(19) United States
(12) Patent Application Publication
(10) Pub. No.: US 2013/0267277 A1
(43) Pub. Date: Oct. 10, 2013

(54) COMMUNICATION SYSTEM, COMMUNICATION METHOD, MOBILE TERMINAL, AND RECORDING MEDIUM

(71) Applicant: SHARP KABUSHIKI KAISHA, Osaka (JP)

(72) Inventor: Masafumi OKIGAMI, Osaka-shi (JP)

(21) Appl. No.: 13/907,583

(22) Filed: May 31, 2013

Related U.S. Application Data
(62) Division of application No. 12/659,503, filed on Mar. 11, 2010.

(30) Foreign Application Priority Data
Mar. 13, 2009 (JP) 200961760

(51) Int. Cl. H04N 1/00

(52) U.S. Cl. CPC H04N 1/00307
USPC 455/557

(57) ABSTRACT

In a communication system, a reception of an image forming device receives image data from a mobile terminal. The image forming device prints an image based on the received image data. The image forming device transmits an address of the reception section to the mobile terminal and receives image data transmitted with the address by the mobile terminal in wireless communication. The mobile terminal accepts a selection of wireless printing application program from plural application programs and displays, side by side, thumbnails of plural items of image data stored in a storage section when the wireless printing application program is started. The mobile terminal further accepts a selection of image data from plural displayed thumbnails and wirelessly transmits the selected image data with the address to the image forming device.

### CROSS-REFERENCE TO RELATED APPLICATIONS

This application is a divisional of U.S. application Ser. No. 12/659,503, filed Mar. 11, 2010, which claims priority under 35 U.S.C. §119(a) on Patent Application No. 2009-61760 filed in Japan on Mar. 13, 2009, the entire contents of which are hereby incorporated by reference.

### BACKGROUND

1. Technical Field

The present invention relates to a communication device, an information processing device for communicating with the communication device, an information processing system provided with the communication device and the information processing device, an image forming device, and an image forming system provided with the image forming device.

2. Description of Related Art

Recently, mobile phones equipped with a camera function have spread widely, and one can easily take a digital photograph anywhere at any time. In addition, memories to be mounted on a mobile phones have been increased in their capacities, and the cases where the mobile phones are used as personal memory devices which save data, such as digital images, business documents, are increasing.

Japanese Patent Application Publication No. 2007-267370 (hereinafter, referred to as “Publicly Known Document 1”) discloses a wireless communication method performed between an IC (Integrated Circuit) chip of a contactless ID (Identification) card and a card reader/writer section of an image processing device, when a user brings his/her contactless ID (Identification) card (or a wireless communication device having the contactless ID card inside) close to the card reader/writer section of the image processing device. In this wireless communication method, the IC chip of the contactless ID card receives a weak electric wave. The weak electric wave is always emitted from the card reader/writer section, and includes a terminal ID indicative of an ID of the image processing device. The IC chip of the contactless ID card obtains the terminal ID from the weak electric wave, and transmits a user ID of the contactless ID card to the image processing device by using the terminal ID.

Further, in Japanese Patent Application Publication No. 2003-32176 (hereinafter, referred to as “Publicly Known Document 2”), a communication system configured for communication between a reader/writer of a personal computer and a mobile phone is disclosed. In this communication system, the mobile phone is provided with the contactless IC card for communicating by electromagnetic waves with the reader/writer of the personal computer. By a user bringing the mobile phone close to the personal computer, the electromagnetic waves radiated from the reader/writer are received by the contactless IC card. At this time, the mobile phone notifies the personal computer of a card ID set in the contactless IC card. Based on the notified card ID, the personal computer identifies the mobile phone and specifies the mobile phone as a partner for communication.

### SUMMARY

According to an aspect of the present invention, a communication system has a mobile terminal and an image forming device. The image forming device includes a reception section that receives image data from the mobile terminal, and prints an image based on the received image data. The image forming device further includes a transmission section that transmits an address of the reception section to the mobile terminal. The image forming device receives image data transmitted with the address by the mobile terminal through the reception section. Communication between the mobile terminal and the image forming device is performed in wireless communication corresponding to an IEEE 802.11 standard. The mobile terminal includes a selection accepting section that accepts a selection of wireless printing application program from plural application programs, a display processing section that displays, side by side, thumbnails of plural items of image data stored in a storage section when the wireless printing application program is started, a data selection accepting section that accepts a selection of image data from plural thumbnails displayed on a display section, and an image data transmission section that wirelessly transmits the selected image data with the address to the image forming device. The image forming device receives the selected image data through the reception section, when the selected image data is transmitted with the address from the mobile terminal.

The above and further objects and features will more fully be apparent from the following detailed description with accompanying drawings.

### BRIEF DESCRIPTION OF THE SEVERAL VIEWS OF THE DRAWINGS

FIG. 1 is a conceptual diagram of an information processing system and an image forming system according to Embodiment 1;

FIG. 2 is a block diagram showing a configuration of an essential construction of the information processing system and the image forming system according to Embodiment 1;

FIG. 3A is a flowchart showing procedures executed by a CPU (Central Processing Unit) of a control section of a digital multi-function peripheral and a CPU of a control section of a mobile phone according to Embodiment 1;

FIG. 3B is a flowchart showing procedures executed by the CPU of the control section of the digital multi-function peripheral and the CPU of the control section of the mobile phone according to Embodiment 1;

FIG. 4 is an illustrated view showing an example of an application selection screen for selecting an application associated with transmission of image data;

FIG. 5 is a diagram illustrating a configuration of a storage area of a contact/contactless IC card according to Embodiment 1;

FIG. 6 is an illustrated view showing an example of a list screen displayed on a display section of the digital multi-function peripheral according to Embodiment 1;

FIG. 7 is a flowchart showing procedures executed by a CPU of a control section of the digital multi-function peripheral and a CPU of a control section of a mobile phone according to Embodiment 2; and

FIG. 8 is a diagram illustrating an operation for selecting an image which a user intends to print out, and an operation for displaying the image which the user has selected on a display section, in the mobile phone according to Embodiment 2;

### DETAILED DESCRIPTION

Hereinafter, an information processing system and an image forming system according to the present invention are specifically described using the drawings. The information processing device and the image forming device each serves as a digital multi-function peripheral that has a copy function, a print function, etc., and a communication device serves herein as a mobile phone.

### Embodiment 1

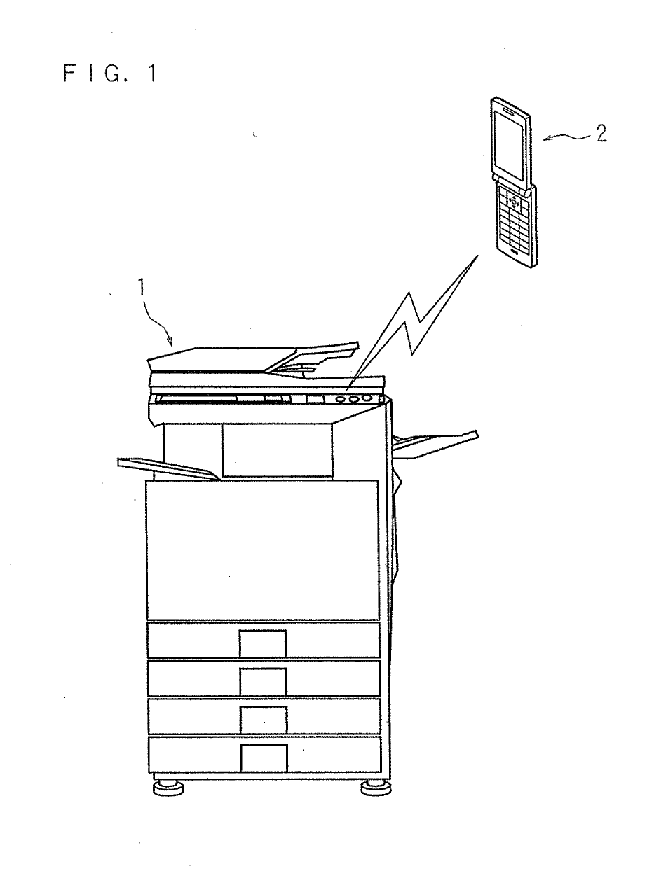

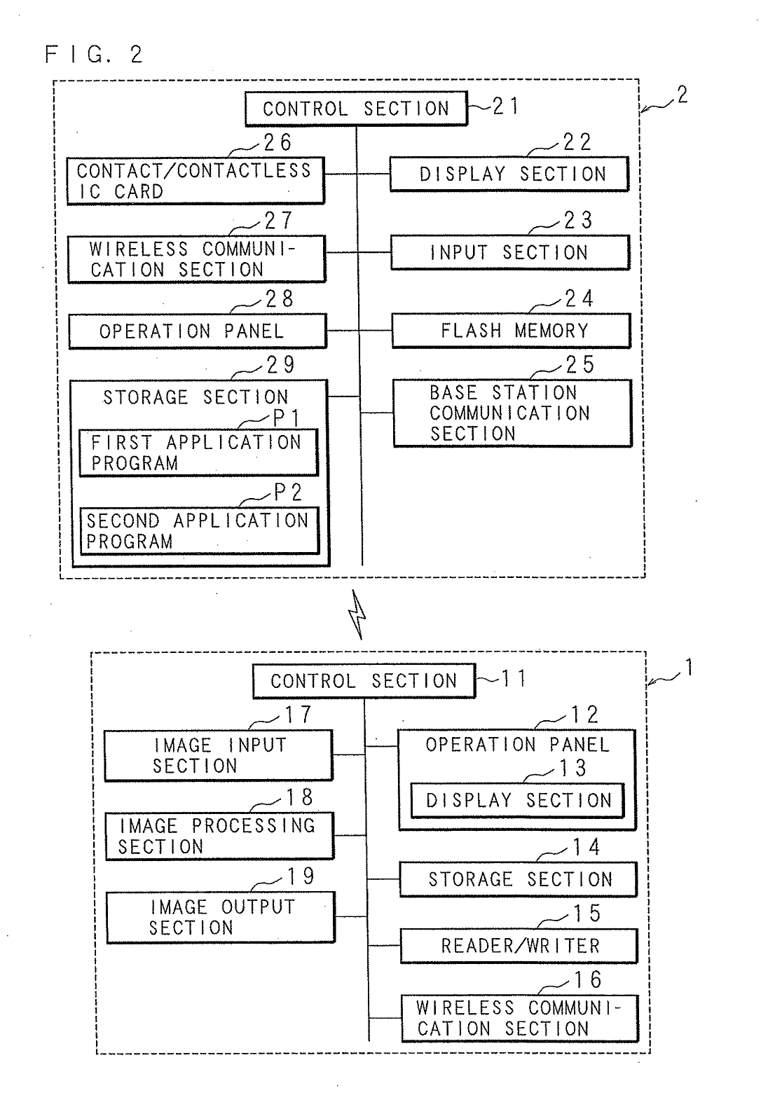

FIG. 1 is a conceptual diagram of the information processing system and the image forming system according to Embodiment 1 of the present invention. FIG. 2 is a block diagram showing a configuration of an essential construction of the information processing system and the image forming system according to Embodiment 1. The information processing system and the image forming system according to Embodiment 1 have a digital multi-function peripheral 1 and a mobile phone 2.

The digital multi-function peripheral 1 includes hardware, such as a control section 11, an image input section 17, an image processing section 18, an image output section 19, a storage section 14, a wireless communication section 16, a reader/writer 15, and an operation panel 12.

The control section 11 includes a CPU and a RAM (Random Access Memory). The CPU controls the hardware described above, and the RAM temporarily stores data required when controlling the hardware. The storage section 14 is a nonvolatile semiconductor memory, etc. The storage section 14 stores image data for image processing, control programs for controlling the hardware described above, programs for displaying a list screen, and image data received via the wireless communication section 16. The programs for displaying the list screen will be described later. A plurality of passkeys are stored in the storage section 14 in advance. When a user operates operation panels 28 or 12, and the CPU of the control section 11 then accepts passkeys from the operation panels 28 or 12, the CPU of the control section 11 compares the accepted passkeys with the passkeys stored in the storage section 14.

The control section 11 loads the control program from the storage section 14 if needed, and then executes the loaded control program. Thereby, the control section 11 operates the digital multi-function peripheral 1 as the image forming device according to the present invention.

The operation panel 12 includes various buttons for accepting instructions from the user, an enter key for accepting confirmation of instructions, a ten-key keypad, etc. Further, the operation panel 12 is provided with a display section 13, such as a liquid crystal display, and displays listings of images, documents, files (contents data) which the mobile phone 2 has, etc. The display section 13 functions as a touch panel display.

The image input section 17 has a reading section for optically reading an image of a document, and a light source that irradiates light to the document to be read. As an example of the light source, an image sensor called “CCDs (Charge Coupled Devices)” is typically used. When a document is set to a predetermined reading position, in the image input section 17, an optical image drawn by the light reflected on the document is formed on the image sensor, and analog electric signals representing RGB (R: Red, G: Green, B: Blue) are outputted. The analog electric signals outputted by the image input section 17 are inputted into the image processing section 18.

The image output section 19 forms an image on a sheet based on the image data outputted from the image processing section 18. The sheet may be a sheet of paper, an OHP sheet, etc. Thus, the image output section 19 includes a photoconductor drum, an electrostatic charger, a laser writing device, a development device, a transferring device, etc. (not shown) to form on the sheet an image which the user wants by using an electrophotographic method. The electrostatic charger charges the photoconductor drum to a predetermined electrical potential. The laser writing device accepts an image data from an exterior device, and then outputs laser beams corresponding to the image data to generate an image of static electricity on the photoconductor drum. The development device develops the image of static electricity by supplying toner to the image of static electricity formed on the surface of the photoconductor drum. The transferring device transfers the image of toner formed on the surface of the photoconductor drum on the sheet. Note that, as methods of forming an image, there are an inkjet method, a heat transfer method, a sublimation method besides the electrophotographic method using the laser writing device, and the image may be formed using any of these methods.

The image processing section 18 converts the analog electric signal outputted from the image input section 17 into digital image data. Then, the image processing section 18 applies processing corresponding to the type of the image to generate image data for output. The generated image data is outputted to the image output section 19 or the wireless communication section 16.

The wireless communication section 16 is a device that supports a Bluetooth communication protocol, for example. The wireless communication section 16 is located within a predetermined short distance (for example, 100 m), and connects by radio with another device supporting the Bluetooth communication protocol (for example, a wireless communication section 27 described later). More specifically, a device supporting the Bluetooth communication protocol has a unique Bluetooth address (identification data). The device supporting the Bluetooth communication protocol performs processing which is so-called “pairing (authenticated)” to specify a partner with which it connects through a network called “the Piconet,” to connect by radio with another device supporting to the Bluetooth communication protocol. The Piconet is a network which will be established dynamically and automatically for one device supporting the Bluetooth communication protocol, when another device supporting the Bluetooth communication protocol comes within a predetermined distance range, and disappear dynamically and automatically when said other device goes out of the predetermined distance range. The wireless communication section 16 is not necessarily a device supporting the Bluetooth communication protocol. For example, the wireless communication section 16 may be a device supporting IEEE 802.11. However, in this case, the device to be connected with the wireless communication section 16 by radio (for example, the wireless communication section 27 described later) must also be a device supporting IEEE 802.11.

The reader/writer 15 transmits and receives data in a RFID system in a state in which it is in contact with or contactless with a contact/contactless IC card 26 described later. In the RFID system, a communication method in which a device which constitutes the system can communicate also in the contactless state is adopted. Hereinafter, communication to be established in the contactless state of the reader/writer 15 and the contact/contactless IC card 26 will be explained. The reader/writer 15 constantly transmits a signal (electromagnetic wave) for starting. When the contact/contactless IC card 26 and the reader/writer 15 approach each other within a distance where they can communicate with each other, the contact/contactless IC card 26 receives the electromagnetic wave transmitted from the reader/writer 15. When the contact/contactless IC card 26 receives the electromagnetic wave, the contact/contactless IC card 26 generates direct current power by rectifying a carrier wave of the electromagnetic wave, and drives an internal circuit with the direct current power. The contact/contactless IC card 26 generates a reply signal by amplitude modulation, and transmits the reply signal corresponding to the signal for starting to the reader/writer 15. As an example of the communication system which the reader/writer 15 and the contact/contactless IC card 26 constitute, there are an RFID system, such as Felica® and Edy®. The reader/writer 15 transmits the unique Bluetooth address (identification data) which the wireless communication section 16 has to the contact/contactless IC card 26.

In order to allow a plurality of devices that support the Bluetooth communication protocol to perform pairing to connect with each other, the user generally needs to perform the following operations. The user searches for another device which is located within a predetermined range from the user's device and supports the Bluetooth communication. The user must specify an address which the user's desired device (the digital multi-function peripheral 1) has from among a plurality of addresses which a plurality of devices retrieved by the search have respectively. However, such a troublesome operations are eliminated in the information processing system and the image forming system according to the present invention.

The mobile phone 2 includes a control section 21 which has a CPU, programs, a ROM (Read-Only Memory), a RAM, etc., and a flash memory 24. The CPU controls hardware which constitutes the mobile phone 2. The ROM records various data, etc. The RAM writes in or reads out data at a high speed. The flash memory 24 has a large capacity and stores telephone numbers, image data, etc. In addition, the flash memory 24 stores image data, such as listing data, images, and thumbnails. The listing data is data for displaying listings of images, documents, files (contents data), etc. which the mobile phone 2 has.

Further, the mobile phone 2 includes a base station communication section 25, an operation panel 28, an input section 23, and a display section 22. The base station communication section 25 has a communication interface and communicates with a base station. The operation panel 28 consists of push buttons for accepting operations by the user. The input section 23 performs acquisition of an image captured by a camera, acceptance of sound inputted into a microphone, etc. The display section 22 performs output of an image by an LCD monitor, etc.

Further, the mobile phone 2 is provided with a storage section 29 for storing various application programs. The storage section 29 stores a first application program P1 and a second application program P2 associated with transmission of data. A transmission method of the data may vary according to application of the first application program P1 or the second application program P2. The first application program P1 responds to predetermined data transmitted from an external device (for example, the digital multi-function peripheral 1), and transmits listing data stored in the flash memory 24. The second application program P2 responds to predetermined data transmitted from an external device, and transmits image data of the image displayed on the display section 22.

The storage section 29 stores a program for displaying an application selection screen described later on the display section 22. The CPU of the mobile phone 2 displays the application selection screen on the display section 22. The first application program P1 or the second application program P2 is selected by the user in the application selection screen. Thereby, the CPU of the mobile phone 2 can receive the user's selection.

The mobile phone 2 includes a contact/contactless IC card 26, and a wireless communication section 27. The contact/contactless IC card 26 transmits and receives data in a contact or contactless state with the reader/writer 15 by using a communication method in which a plurality of devices can communicate with each other also in the contactless state. As an example of the communication system using this communication method, an RFID system, such as Felica® or Edy® may be adopted. The wireless communication section 27 is a device supporting a Bluetooth communication protocol, for example. When another device supporting the Bluetooth communication protocol (for example, the wireless communication section 16) is located within a predetermined distance (for example, 100 m) from the wireless communication section 27, the wireless communication section 27 connects and communicates with that device by radio.

The mobile phone 2 can select a transmission method of data when the user transmits the data stored in the mobile phone 2. That is, the user selects the first application program P1 or the second application program P2 by operating the operation panel 28. The first application program P1 and the second application program P2 are stored in the storage section 29. The mobile phone 2 selects the transmission method of data by the user's selection. When the user selects the first application program P1, the listing data associated with file names of images and documents, etc. stored in the flash memory 24 is transmitted to the partner for communication. When the user selects an image from the listing data in the partner for communication, image data of the selected image is transmitted from the mobile phone 2 to the partner for communication. On the other hand, when the user selects the second application program P2, data associated with the image displayed on the display section 22 of the mobile phone 2 is transmitted to the partner for communication.

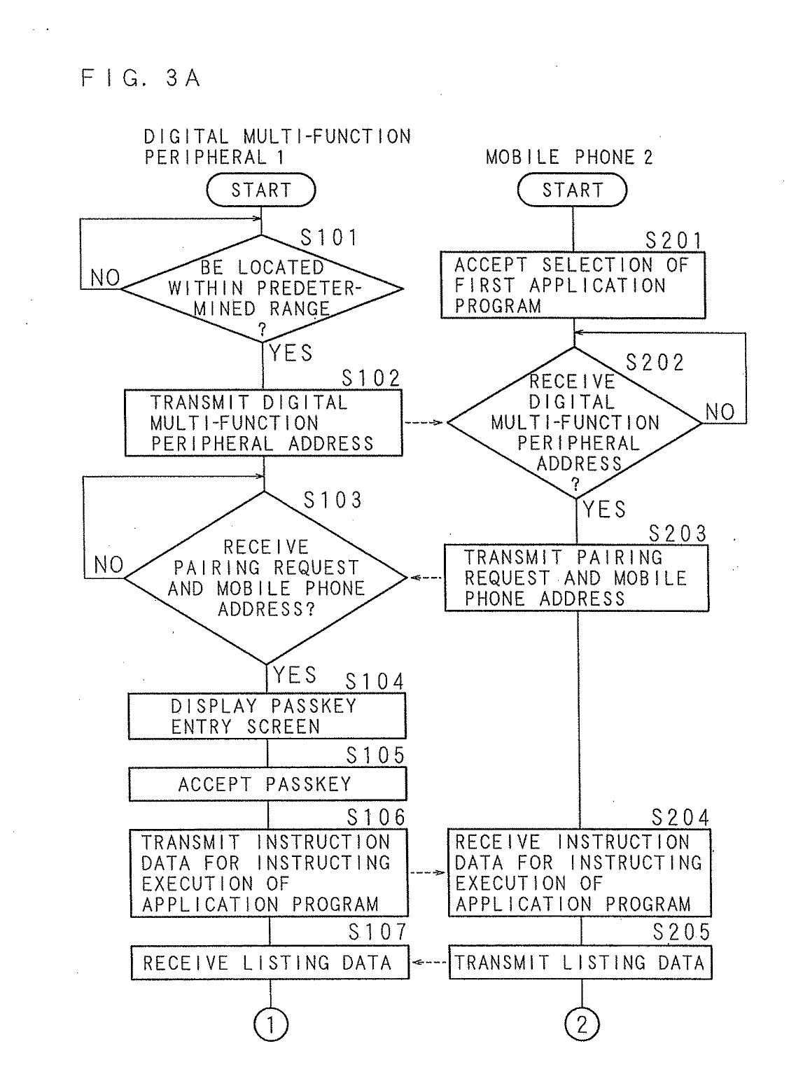

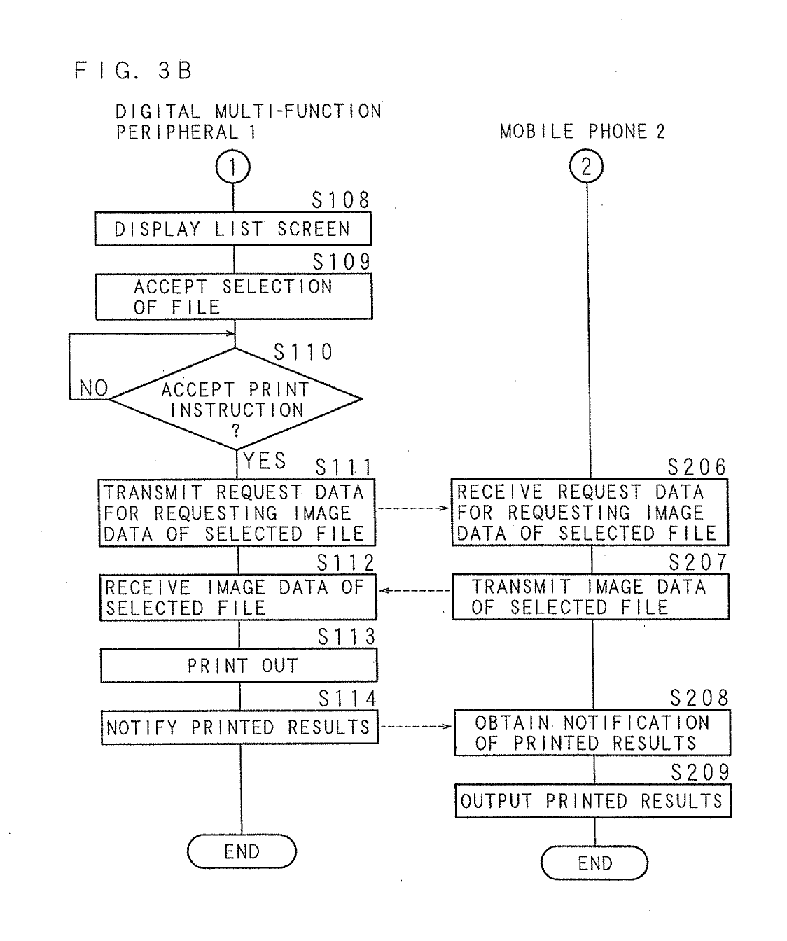

Hereinafter, the information processing system, the information processing device and the communication device and the image forming system and the image forming device, according to Embodiment 1, are described. As an example of the processing which they perform, processing which the digital multi-function peripheral 1 and the mobile phone 2 perform (information processing, image formation) is described. As an example of the processing which the digital multi-function peripheral 1 and the mobile phone 2 perform (the information processing and the image formation), Embodiment 1 is described about the case where the mobile phone 2 transmits image data stored in the mobile phone 2 to the digital multi-function peripheral 1 and the digital multi-function peripheral 1 then prints out an image on a sheet. FIG. 3A and FIG. 3B are a flowchart showing procedures executed by the CPU of the control section 11 of the digital multi-function peripheral 1 and the CPU of the control section 21 of the mobile phone 2, according to Embodiment 1. Note that, in the information processing system and the image forming system according to Embodiment 1, both the digital multi-function peripheral 1 and the mobile phone 2 are devices that support a Bluetooth communication protocol.

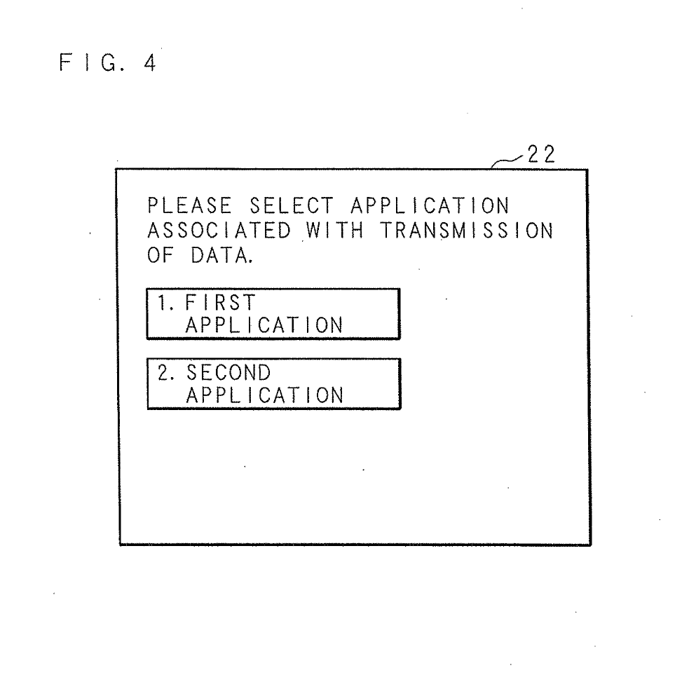

Before the user transmits image data to the digital multi-function peripheral 1 from the mobile phone 2, he/she operates the operation panel 28 of the mobile phone 2 and to select an application associated with the image data. Hereinafter, the case where the user selects the first application program P1 is described for the sake of convenience of explanation. FIG. 4 is an illustrated view showing an example of the application selection screen for selecting an application associated with transmission of image data. In the application selection screen, items of “1. FIRST APPLICATION” and “2. SECOND APPLICATION” are displayed as choices. The user can select one item by appropriately operating the operation panel 28.

The user selects the first application by operating the operation panel 28 and, thus, the first application program P1 is selected. The CPU of the mobile phone 2 then accepts the selection of the first application program P1 via the operation panel 28 (Step S201).

The CPU of the digital multi-function peripheral 1 determines whether the mobile phone 2 is located within a predetermined range (Step S101). The reader/writer 15 included in the digital multi-function peripheral 1 constantly transmits the signal (electromagnetic wave) for starting. When the user holds the mobile phone 2 over the reader/writer 15 of the digital multi-function peripheral 1, a reply signal corresponding to the signal for starting is transmitted to the reader/writer 15 by the technique described above from the contact/contactless IC card 26 of the mobile phone 2. When the reply signal is received, the CPU of the digital multi-function peripheral 1 determines that the mobile phone 2 is located within the predetermined range.

If it determines that the mobile phone 2 is not located within the predetermined range (Step S101: NO), the CPU of the digital multi-function peripheral 1 stands by until the mobile phone 2 is located within the predetermined range. If it determines that the mobile phone 2 is located within the predetermined range (Step S101: YES), the CPU of the digital multi-function peripheral 1 then reads the Bluetooth address which the wireless communication section 16 has (hereinafter, referred to as a “digital multi-function peripheral address”), and then transmits the digital multi-function peripheral address to the reader/writer 15. The reader/writer 15 then transmits the digital multi-function peripheral address (identification data) to the contact/contactless IC card 26 of the mobile phone 2 (Step S102).

The CPU of the mobile phone 2 determines whether the contact/contactless IC card 26 has received the digital multi-function peripheral address by monitoring the contact/contactless IC card 26 (Step S202). If it determines that the contact/contactless IC card 26 has not received the digital multi-function peripheral address (Step S202: NO), the CPU of the mobile phone 2 stands by until the contact/contactless IC card 26 receives the digital multi-function peripheral address. If it determines that the contact/contactless IC card 26 has received the digital multi-function peripheral address (Step S202: YES), the CPU of the mobile phone 2 stores the digital multi-function peripheral address which the contact/contactless IC card 26 has received in a storage area of the contact/contactless IC card 26.

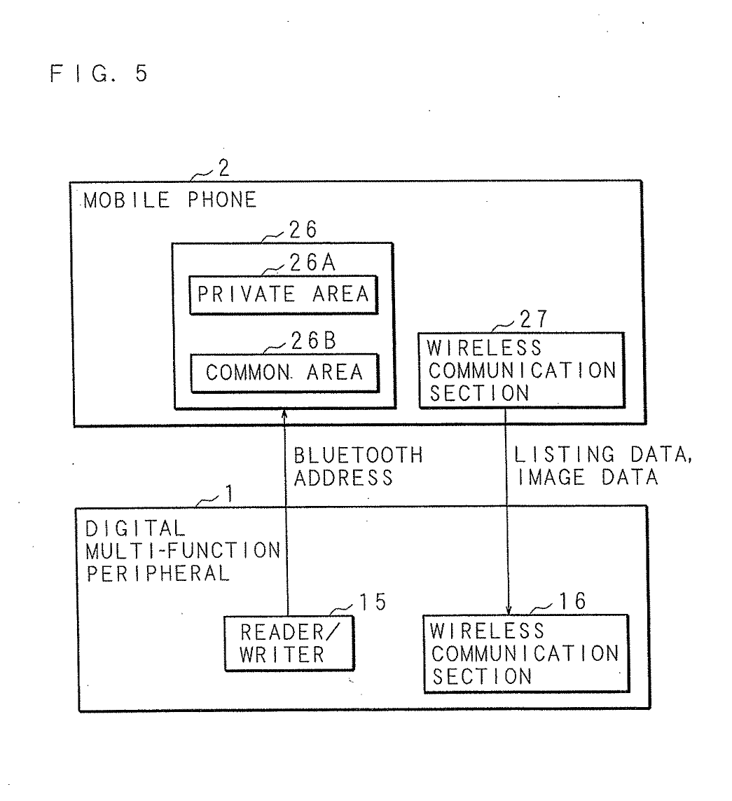

FIG. 5 is a diagram illustrating a configuration of the storage area of the contact/contactless IC card 26 according to Embodiment 1. In the storage area of the contact/contactless IC card 26, there are a private area 26A (free area) and a common area 26B. The digital multi-function peripheral address (identification data) which the contact/contactless IC card 26 has received is written in the private area 26A. The private area 26A is an area where a service provider can use freely. A high degree of freedom in writing can be obtained by using the private area 26A. On the other hand, the CPU of the mobile phone 2 can also write data in the common area 26B. However, in this case, the service provider must use a remote issue system for a network which the contact/contactless IC card 26 has. For this reason, the common area 26B has a problem that the degree of freedom in writing is low.

The CPU of the mobile phone 2 requests pairing from the digital multi-function peripheral 1, and transmits a Bluetooth address (hereinafter, referred to as a “mobile phone address”) of the wireless communication section 27 (Step S203). More specifically, the wireless communication section 27 of the mobile phone 2 transmits the mobile phone address and the data for requesting the pairing to the wireless communication section 16 of the digital multi-function peripheral 1.

By monitoring the wireless communication section 16, the CPU of the digital multi-function peripheral 1 determines whether the wireless communication section 16 has received the pairing request and the mobile phone address from the mobile phone 2 (Step S103). If it determines that the wireless communication section 16 has not received the pairing request and the mobile phone address (Step S103: NO), the CPU of the digital multi-function peripheral 1 stands by until the wireless communication section 16 receives the pairing request and the mobile phone address from the mobile phone 2. On the other hand, if it determines that wireless communication section 16 has received the pairing request and the mobile phone address (Step S103: YES), the CPU of the digital multi-function peripheral 1 stores the mobile phone address which the wireless communication section 16 has received in the storage section 14. Then, the CPU of the digital multi-function peripheral 1 displays a passkey entry screen which prompts the user to enter a passkey on the display section 13 of the operation panel 12 (Step S104). The CPU of the digital multi-function peripheral 1 thus requests entry from the user.

The user then operates the operation panel 12 or the display section 13 (if it is a touch panel) to enter the passkey. The CPU of the digital multi-function peripheral 1 accepts the passkey which the user has entered via the operation panel 12 or the display section 13 (if it is a touch panel) (Step S105). The CPU of the digital multi-function peripheral 1 stores the passkey temporarily in the storage section 14.

The CPU of the digital multi-function peripheral 1 compares the passkey entered by the user with a passkey stored in advance in the storage section 14. If the CPU of the digital multi-function peripheral 1 determines that the entered passkey is correct, the pairing is completed, and the digital multi-function peripheral 1 and the mobile phone 2 are connected with each other. The digital multi-function peripheral 1 and the mobile phone 2 are set to a state in which they can communicate with each other. On the other hand, if the CPU of the digital multi-function peripheral 1 determines that the entered passkey is not correct, it notifies this and the CPU of the digital multi-function peripheral 1 displays a screen which prompts the user for an entry by the user again on the display section 13.

Then, the CPU of the digital multi-function peripheral 1 transmits instruction data for instructing execution of the application program via the wireless communication section 16 to the mobile phone 2 (Step S106).

The CPU of the mobile phone 2 receives the instruction data for instructing execution of the application program from the digital multi-function peripheral 1 via the wireless communication section 27 (Step S204).

The CPU of the mobile phone 2 executes the first application program P1 which is selected by the user at Step S201 and is accepted by the CPU of the mobile phone 2. More specifically, the CPU of the mobile phone 2 receives the instruction data for instructing execution of the application program. The CPU of the mobile phone 2 then reads out the listing data stored in the flash memory 24, and transmits the listing data to the wireless communication section 16 of the digital multi-function peripheral 1 via the wireless communication section 27 (Step S205).

The CPU of the digital multi-function peripheral 1 receives via the wireless communication section 16 the listing data transmitted from the mobile phone 2 (Step S107). The CPU of the digital multi-function peripheral 1 then stores the listing data in the storage section 14.

The CPU of the digital multi-function peripheral 1 displays a list screen on the display section 13 based on the listing data stored in the storage section 14 (Step S108). The list screen is a screen from which a selection of a file which the user wants to print out is accepted from the user.

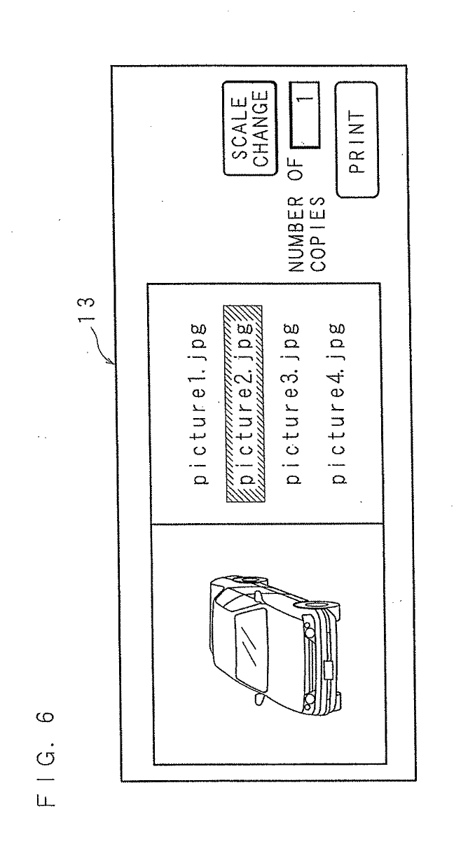

FIG. 6 is an illustrated view showing an example of the list screen displayed on the display section 13 of the digital multi-function peripheral 1 according to Embodiment 1. In the list screen, a plurality of file names are displayed based on the listing data on a screen which can be scrolled, for example. When the user selects a file by operating the operation panel 12 or the display section 13 (if it is a touch panel), thumbnails of the file are displayed on the list screen. In the list screen, soft keys representing “scale change,” “number of copies,” and “print,” etc., are provided. By these keys, the digital multi-function peripheral 1 can accept printing conditions, such as the number of copies to be printed and a scale change factor from the user. After the user selects a file which he/she wants to print out and inputs printing conditions, he/she operates the “print” soft key. By this operation, the user instructs the digital multi-function peripheral 1 to start printing. Thus, by the user operating the operation panel 12 or the display section 13 (if it is a touch panel) in the digital multi-function peripheral 1, it becomes unnecessary for the user to operate small keys of the mobile phone 2 while looking at the small LCD monitor screen of the mobile phone 2. Because the user operates the large operation panel 12 or the large display section 13 of the digital multi-function peripheral 1, operability of the keys and referencability of the image will be higher.

The CPU of the digital multi-function peripheral 1 accepts from the user selection of a file which the user wants to print out, via the operation panel 12 or the display section 13 (if it is a touch panel) (Step S109). If the selection of a file is accepted from the user, the CPU of the digital multi-function peripheral 1 determines whether it has accepted print instruction from the user (Step S110). This determination is performed by the CPU of the digital multi-function peripheral 1 monitoring the operation panel 12 and the display section 13 (if it is a touch panel).

If the CPU of the digital multi-function peripheral 1 determines that it has not accepted the print instruction from the user (Step S110: NO), it stands by until it receives the print instruction from the user. On the other hand, if the CPU of the digital multi-function peripheral 1 determines that it has accepted the print instruction from the user (Step S110: YES), it transmits request data for requesting the mobile phone 2 for the image data of the selected file (hereinafter, referred to as the “selected file”), to the mobile phone 2 via the wireless communication section 16 (Step S111).

The CPU of the mobile phone 2 receives the request data for requesting the image data of the selected file from the digital multi-function peripheral 1 via the wireless communication section 27 (Step S206). The CPU of the mobile phone 2 then receives the request data, and reads out the image data of the selected file from the flash memory 24. The CPU of the mobile phone 2 then transmits the image data of the selected file to the digital multi-function peripheral 1 via the wireless communication section 27 (Step S207).

The CPU of the digital multi-function peripheral 1 receives the image data of the selected file from the mobile phone 2 via the wireless communication section 16 (Step S112). The CPU of the digital multi-function peripheral 1 then stores the image data in the storage section 14.

The CPU of the digital multi-function peripheral 1 transmits the image data stored in the storage section 14 to the image output section 19. The CPU of the digital multi-function peripheral 1 instructs the image output section 19 to print out the image based on the image data, and prints out the image on a sheet (Step S113).

The CPU of the digital multi-function peripheral 1 transmits data that notifies the printed results to the mobile phone 2 via the wireless communication section 16 (Step S114). The printed results include normal completion of printing, occurrence of abnormality during printing, etc. At Step S114, the CPU of the digital multi-function peripheral 1 terminates the processing.

The CPU of the mobile phone 2 obtains the data that notifies the printed results via the wireless communication section 27 from the digital multi-function peripheral 1 (Step S208). The CPU of the mobile phone 2 stores the data in the flash memory 24.

The CPU of the mobile phone 2 outputs the printed results to the display section 22 based on the data stored in the flash memory 24 (Step S209). At Step S209, the CPU of the mobile phone 2 terminates the processing. Here, as a method that the CPU of the mobile phone 2 outputs the printed results, there is a method of displaying the printed results on the LCD monitor of the mobile phone 2 in text data. Alternatively, the CPU of the mobile phone 2 may not output the printed results to the display section 22 but outputs a sound or an alarm from a speaker of the mobile phone 2 to notify the printed results.

As described above, in the information processing system and the image forming system according to Embodiment 1, the mobile phone 2 receives the digital multi-function peripheral address from the digital multi-function peripheral 1, and the user then transmits data from the mobile phone 2 using the digital multi-function peripheral address. Thereby, it is prevented in advance that the secret information (the address, the passkey, etc.) of the mobile phone 2 leaks against the user's intention.

In the description of Embodiment 1, the user manually enters the passkey in order to set the passkey certainly. However, if priority is given to a user's convenience, the reader/writer 15 of the digital multi-function peripheral 1 and the contact/contactless IC card 26 of the mobile phone 2 may deliver the passkey from one to the other.

Note that, if the information processing system and the image forming system according to the present invention are configured with devices to which a passkey cannot be entered (a mouse, a headset, etc.), the passkey may be a fixed value, or the entry operation of the passkey may be omitted. Further, if the device to which a passkey cannot be entered is used, the passkey may be a passkey of simple enumeration, such as “0000,” as its default value.

### Embodiment 2

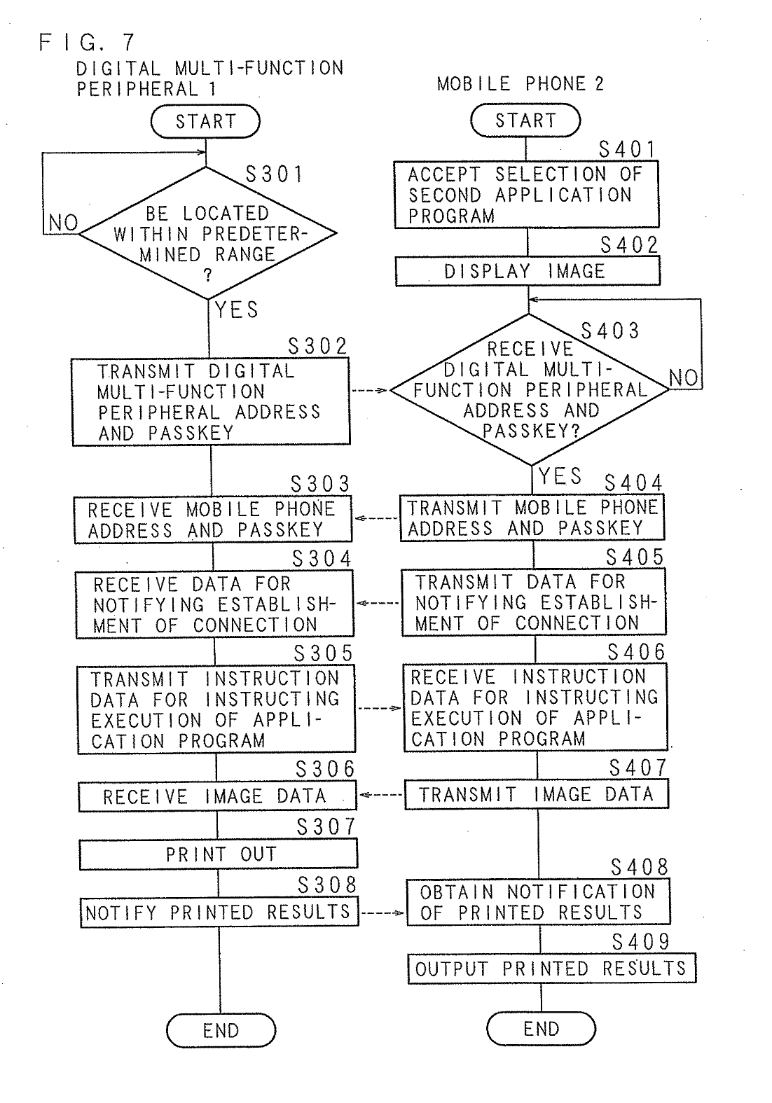

Hereinbelow, an information processing system, an information processing device and a communication device, and an image forming system and an image forming device according to Embodiment 2 are described. As examples of processing which they perform, processing which the digital multi-function peripheral 1 and the mobile phone 2 perform (information processing, image formation) are described. As an example of the processing which the digital multi-function peripheral 1 and the mobile phone 2 perform (information processing, image formation), Embodiment 2 is described about the case where the mobile phone 2 transmits image data stored in the mobile phone 2 to the digital multi-function peripheral 1, and the digital multi-function peripheral 1 prints out the image on a sheet. In the information processing system and the image forming system according to Embodiment 2, the reader/writer 15 of the digital multi-function peripheral 1 and the contact/contactless IC card 26 of the mobile phone 2 deliver a passkey from one to the other. FIG. 7 is a flowchart showing procedures executed by the CPU of the control section 11 of the digital multi-function peripheral 1 and the CPU of the control section 21 of the mobile phone 2, according to Embodiment 2.

Similar to Embodiment 1, before the user transmits the image data to the digital multi-function peripheral 1, he/she operates the operation panel 28 of the mobile phone 2 to select an application program associated with the image data. Hereinafter, the case where the user selects the second application program P2 is described for the sake of convenience of explanation.

Similar to Embodiment 1, the user operates the operation panel 28 to select the second application program P2, and the CPU of the mobile phone 2 accepts the selection of the second application program P2 via the operation panel 28 (Step S401).

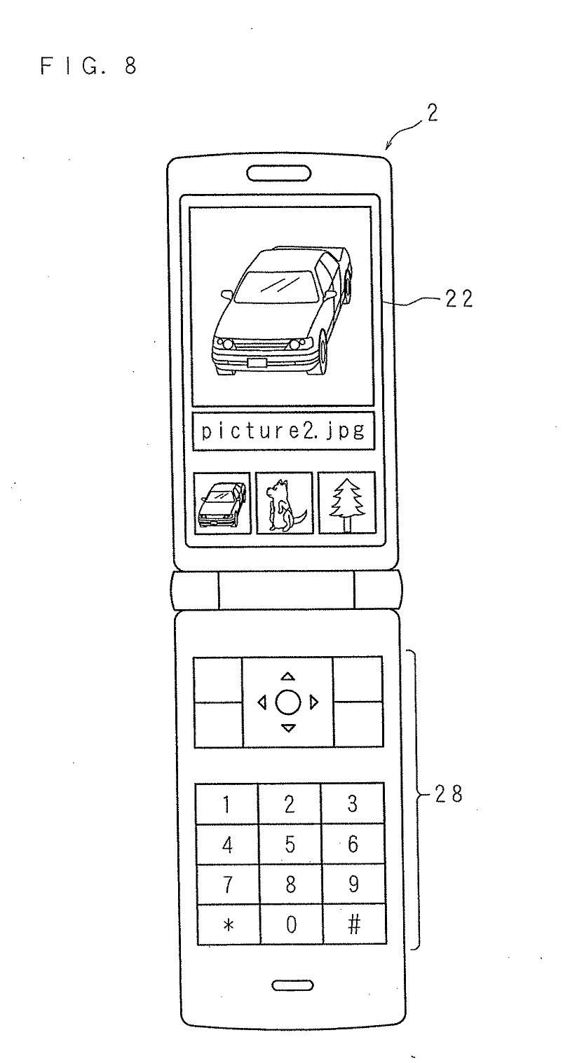

The user selects an image to be printed out by operating the mobile phone 2. The mobile phone 2 displays the image on the display section 22 (Step S402). FIG. 8 is a diagram illustrating an operation for selecting the image which the user intends to print out, and an operation for displaying the image which the user has selected on the display section 22, in the mobile phone 2 according to Embodiment 2. On the display section 22 of the mobile phone 2, thumbnails of the image data stored in the flash memory 24 are displayed. The user operates the operation panel 28 (a push button, etc.) to move a cursor. Thereby, the user can select one of the thumbnails. When the user selects one of the thumbnails, the name of a file associated with the selected thumbnail (hereinafter, a selected file) and an enlarged thumbnail are displayed on the display section 22. After selecting the file which the user wants to print out, he/she holds the mobile phone 2 over the reader/writer 15 of the digital multi-function peripheral 1.

The CPU of the digital multi-function peripheral 1 determines whether the mobile phone 2 is located within a predetermined range (Step S301). The determination method is the same as the method described in Embodiment 1. If the CPU of the digital multi-function peripheral 1 determines that the mobile phone 2 is not located within the predetermined range (Step S301: NO), it stands by until the mobile phone 2 is located within the predetermined range. On the other hand, if the CPU of the digital multi-function peripheral 1 determines that the mobile phone 2 is located within the predetermined range (Step S301: YES), it reads out a Bluetooth address (hereinafter, referred to as a “digital multi-function peripheral address”) and a passkey which the wireless communication section 16 has, and transmits the digital multi-function peripheral address and the passkey to the reader/writer 15. The reader/writer 15 transmits the digital multi-function peripheral address and the passkey to the contact/contactless IC card 26 of the mobile phone 2 (Step S302).

The CPU of the mobile phone 2 determines by monitoring the contact/contactless IC card 26 whether the contact/contactless IC card 26 has received the digital multi-function peripheral address and the passkey (Step S403). If the CPU of the mobile phone 2 determines that the contact/contactless IC card 26 has not received the digital multi-function peripheral address and the passkey (Step S403: NO), it stands by until the contact/contactless IC card 26 receives the digital multi-function peripheral address and the passkey. On the other hand, if the CPU of the mobile phone 2 determines that contact/contactless IC card 26 has received the digital multi-function peripheral address and the passkey (Step S403: YES), it stores the digital multi-function peripheral address and the passkey, which the contact/contactless IC card 26 has received, in a storage area of the contact/contactless IC card 26.

The CPU of the mobile phone 2 transmits a Bluetooth address (hereinafter, referred to as a “mobile phone address”) and the passkey of the wireless communication section 27 which are stored in the flash memory 24 to the digital multi-function peripheral 1 via the wireless communication section 27 (Step S404). The mobile phone 2 is connected with the digital multi-function peripheral 1 at Step S404.

The CPU of the digital multi-function peripheral 1 receives the mobile phone address and the passkey from the mobile phone 2 via the wireless communication section 16 (Step S303). The CPU of the digital multi-function peripheral 1 stores the mobile phone address and the passkey in the storage section 14. By the digital multi-function peripheral 1 receiving the mobile phone address and the passkey from the mobile phone 2, pairing of the digital multi-function peripheral 1 and the mobile phone 2 is completed. The digital multi-function peripheral 1 and the mobile phone 2 are connected with each other, and the digital multi-function peripheral 1 and the mobile phone 2 are set into a state in which communication is possible between them.

The CPU of the mobile phone 2 transmits data, which notifies that it is connected with the digital multi-function peripheral 1, to the digital multi-function peripheral 1 via the wireless communication section 27 (Step S405). Thereby, the CPU of the mobile phone 2 notifies to the digital multi-function peripheral 1 that the mobile phone 2 is connected with the digital multi-function peripheral 1.

The CPU of the digital multi-function peripheral 1 then receives the data, which notifies that the digital multi-function peripheral 1 is connected with the mobile phone 2, from the mobile phone 2 via the wireless communication section 16 (Step S304). The CPU of the digital multi-function peripheral 1 then transmits instruction data for instructing execution of an application program to the mobile phone 2 via the wireless communication section 16 (Step S305).

The CPU of the mobile phone 2 receives the instruction data for instructing execution of the application program from the digital multi-function peripheral 1 via the wireless communication section 27 (Step S406).

The CPU of the mobile phone 2 executes the second application program P2 selected by the user at Step S401 and accepted by the CPU of the mobile phone 2. More specifically, the CPU of the mobile phone 2 receives the instruction data for instructing execution of the application program. The CPU of the mobile phone 2 reads out from the flash memory 24 the image data of the image displayed on the display section 22 when the mobile phone 2 receives the instruction data. The image described herein is an image displayed on the display section 22 at Step S402. The CPU of the mobile phone 2 then transmits the image data to the wireless communication section 16 of the digital multi-function peripheral 1 via the wireless communication section 27 (Step S407).

The CPU of the digital multi-function peripheral 1 receives the image data from the mobile phone 2 via the wireless communication section 16 (Step S306). The CPU of the digital multi-function peripheral 1 then stores the image data in the storage section 14.

The CPU of the digital multi-function peripheral 1 transmits the image data stored in the storage section 14 to the image output section 19. The CPU of the digital multi-function peripheral 1 then instructs the image output section 19 to print out the image based on the image data, and then prints out the image on a sheet (Step S307).

The CPU of the digital multi-function peripheral 1 then transmits data, which notifies the printed results, to the mobile phone 2 via the wireless communication section 16 (Step S308). The printed results include normal completion of printing, occurrence of abnormality during printing, etc. At Step S308, the CPU of the digital multi-function peripheral 1 terminates the processing.

The CPU of the mobile phone 2 obtains the data, which notifies the printed results, from the digital multi-function peripheral 1 via the wireless communication section 27 (Step S408). The CPU of the mobile phone 2 then stores the data in the flash memory 24.

The CPU of the mobile phone 2 then outputs the printed results to the display section 22 based on the data stored in the flash memory 24 (Step S409). At Step S409, the CPU of the mobile phone 2 terminates the processing.

As described above, in the information processing system and the image forming system according to Embodiment 2, the user selects the file of an image to be printed out by operating the mobile phone 2, and then brings the mobile phone 2 close to the digital multi-function peripheral 1. Thereby, the user can print out the image immediately, and the print job will be very easy.

In the description of Embodiment 2, like reference numerals are assigned to like components with respect to Embodiment 1 and, thus, the detailed descriptions about the components are omitted.

In the description of Embodiment 1 or 2, the digital multi-function peripheral 1 has two application programs associated with transmission of the data. However, the number of application programs is not limited to two. Many application programs may be provided to meet the user's needs to improve the user friendliness. Alternatively, one of the application programs may be executed synchronously with another other application program. For example, if the second application program P2 is selected at the digital multi-function peripheral 1 for rent installed in a convenience store, every time image data is transmitted from the mobile phone 2, an application program associated with billing of electronic money may be executed synchronously with the transmission.

In Embodiment 1 or 2, the information processing system, the information processing device, the communication device, the image forming system, and the image forming device according to the present invention are described using the digital multi-function peripheral 1 and the mobile phone 2. However, the devices that constitute the information processing system, the information processing device, the communication device, the image forming system, and the image forming device according to the present invention may not be limited to the digital multi-function peripheral 1 and the mobile phone 2. For example, the mobile phone 2 may be a digital camera that has a communication function. The mobile phone 2 may be also a personal digital assistant which is called a “mobile computer” or a “PDA (Personal Digital Assistance).” Further, the digital multi-function peripheral 1 may transmit to the mobile phone 2 data of a document image scanned by a scanner which the digital multi-function peripheral 1 has, as well as the mobile phone 2 transmits data to the digital multi-function peripheral 1. Alternatively, the digital multi-function peripheral 1 may transmit to the mobile phone 2 data of facsimile images, electronic data and the like accumulated in the memory storage of the digital multi-function peripheral 1. Further, even if the information processing system, the information processing device, the communication device, the image forming system, and the image forming device according to the present invention are constituted with devices that includes two or more communication sections and can communicate with each other, similar effects described in Embodiment 1 or 2 can also be attained. The devices that includes two or more communication sections and can communicate with each other may include the digital multi-function peripheral 1 having the reader/writer 15 and the wireless communication section 16, or the mobile phone 2 having the contact/contactless IC card 26 and the wireless communication section 27, for example.

In Embodiment 1 or 2, the user holds the mobile phone 2 over the reader/writer 15 of the digital multi-function peripheral 1, and the digital multi-function peripheral address is transmitted to the contact/contactless IC card 26 of the mobile phone 2 from the reader/writer 15. However, the transmission method is not limited to this. For example, when the user holds the mobile phone 2 over the reader/writer 15 of the digital multi-function peripheral 1, the mobile phone address may be transmitted to the reader/writer 15 from the contact/contactless IC card 26 of the mobile phone 2. Alternatively, instruction data for instructing execution of an application program may be transmitted instead of the address.

In Embodiment 1 or 2, the digital multi-function peripheral 1 receives image data from the mobile phone 2 and prints out an image based on the image data. However, processing of the digital multi-function peripheral 1 is not limited to printing of an image (image formation) based on image data. Even if the digital multi-function peripheral 1 processes the data, the information processing system, the information processing device, the communication device, the image forming system, and the image forming device according to the present invention can obtain similar effects to those of the present invention described in Embodiment 1 or 2. The data processing is processing, such as editing of text data, changing a scale of an image, or rotating of the image data, performed when the digital multi-function peripheral 1 receives text data, image data, or the like from a personal digital assistant called a “mobile computer” or “PDA.”

As this description may be embodied in several forms without departing from the spirit of essential characteristics thereof, the present embodiment is therefore illustrative and not restrictive, because the scope is defined by the appended claims rather than by the description preceding them and all changes that fall within metes and bounds of the claims, or equivalence of such metes and bounds thereof are therefore intended to be embraced by the claims.

What is claimed is:

1. A communication system having a mobile terminal and an image forming device, the image forming device including a reception section that receives image data from the mobile terminal and printing an image based on the received image data,
wherein the image forming device further includes a transmission section that transmits an address of the reception section to the mobile terminal,
wherein the reception section receives image data transmitted with the address by the mobile terminal,
wherein communication between the mobile terminal and the image forming device is performed in wireless communication corresponding to an IEEE 802.11 standard,
wherein the mobile terminal includes:
a selection accepting section that accepts a selection of wireless printing application program from plural application programs;
a display processing section that displays, side by side, thumbnails of plural items of image data stored in a storage section when the wireless printing application program is started;
a data selection accepting section that accepts a selection of image data from plural thumbnails displayed on a display section; and
an image data transmission section that wirelessly transmits the selected image data with the address to the image forming device,
wherein the reception section receives the selected image data, when the selected image data is transmitted with the address from the mobile terminal.

2. A communication method with a mobile terminal and an image forming device, the image forming device including a reception section that receives image data from the mobile terminal and printing an image based on the received image data,
wherein the image forming device:
transmits an address of the reception section to the mobile terminal;
receives image data transmitted with the address by the mobile terminal through the reception section; and
communicates with the mobile terminal in wireless communication corresponding to an IEEE 802.11 standard,
wherein the mobile terminal:
accepts a selection of wireless printing application program from plural application programs;
displays, side by side, thumbnails of plural items of image data stored in a storage section, when the wireless printing application program is started;
accepts a selection of image data from plural thumbnails displayed on a display section; and
wirelessly transmits the selected image data with the address to the image forming device,
wherein the image forming device receives the selected image data through the reception section, when the selected image data is transmitted with the address from the mobile terminal.

3. A mobile terminal, comprising:
a selection accepting section that accepts a selection of wireless printing application program from plural application programs;
an address reception section that receives an address of a reception section of an image forming device in wireless communication corresponding to an IEEE 802.11 standard when the wireless printing application program is started;
a display processing section that displays, side by side, thumbnails of plural items of image data stored in a storage section when the wireless printing application program is started;
a data selection accepting section that accepts a selection of image data from plural thumbnails displayed on a display section; and
an image data transmission section that wirelessly transmits the selected image data with the address to the image forming device.

4. The mobile terminal according to claim 3,
wherein printed result information is displayed on the display section, when the wireless printing application program is started and the printed result information wirelessly transmitted is received through the reception section from the image forming device.

5. A non-transitory recording medium that records program executable by a mobile terminal, comprising:
a selection accepting step of accepting a selection of wireless printing application program from plural application programs;
an address reception step of receiving an address of a reception section of an image forming device in wireless communication corresponding to an IEEE 802.11 standard when the wireless printing application program is started;
a display processing step of displaying, side by side, thumbnails of plural items of image data stored in a storage section when the wireless printing application program is started;
a data selection accepting step of accepting a selection of image data from plural thumbnails displayed on a display section; and
an image data transmission step of wirelessly transmitting the selected image data with the address to the image forming device.

6. The recording medium according to claim 5, further comprising:
a step of displaying printed result information on the display section, when the wireless printing application program is started and the printed result information wirelessly transmitted is received through the reception section from the image forming device.
